(19) United States
(12) Patent Application Publication
(10) Pub. No.: US 2017/0116462 A1
(43) Pub. Date: Apr. 27, 2017

(54) MEASUREMENT APPARATUS AND METHOD, PROGRAM, ARTICLE MANUFACTURING METHOD, CALIBRATION MARK MEMBER, PROCESSING APPARATUS, AND PROCESSING SYSTEM

(71) Applicant: CANON KABUSHIKI KAISHA, Tokyo (JP)

(72) Inventor: Makiko Ogasawara, Utsunomiya-shi (JP)

(21) Appl. No.: 15/298,039

(22) Filed: Oct. 19, 2016

(30) Foreign Application Priority Data
Oct. 22, 2015 (JP) 2015-208241
Mar. 3, 2016 (JP) 2016-041579

(51) Int. Cl. G06K 9/00; G06K 9/40; G06K 9/20; H04N 17/00

(52) U.S. Cl. CPC G06K 9/00201; H04N 17/002; G06K 9/40; G06K 9/2036

(57) ABSTRACT

A measurement apparatus includes: a projection device configured to project, upon an object, light having a pattern and light not having a pattern; an imaging device configured to image the object upon which the light having a pattern has been projected and obtain a pattern image, and image the object upon which the light not having a pattern has been projected and obtain an intensity image; and a processor configured to perform processing of recognizing a region of the object, by performing processing of correcting distortion in the pattern image, based on first calibration data, and performing processing of correcting distortion in the intensity image, based on second calibration data different from the first calibration data.

### BACKGROUND OF THE INVENTION

Field of the Invention

The present invention relates to a measurement apparatus and method, a program, an article manufacturing method, a calibration mark member, a processing apparatus, and a processing system.

Description of the Related Art

Pattern projection method is one way to measure (recognize) a region (three-dimensional region) of an object. In this method, light that has been patterned in stripes, for example (pattern light or structured light) is projected on an object, the object on which the pattern light has been projected is imaged, and a pattern image is obtained. The object is also approximately uniformly illuminated and imaged, thereby obtaining an intensity image or gradation image (without a pattern). Next, calibration data (data or parameters for calibration) are used to calibrate (correct) the pattern image and intensity image, in order to correct distortion of the image. The region of the object is measured based on the calibrated pattern image and intensity image.

There is a known calibration data obtaining method where marks (indices), having known three-dimensional coordinates, are imaged under predetermined conditions, thereby obtaining an image. The calibration data obtaining is based on the correlation between the coordinates of the marks and the known coordinates on the image thus obtained (Japanese Patent Laid-Open No. 2013-36831). Conventional measurement apparatuses have performed calibration of images with just one type of calibration data stored for one imaging device (imaging apparatus).

However, distortion (distortion amount) of the image obtained by the imaging device changes in accordance with the light intensity distribution on the object to be imaged, and the point spread function of the imaging device. Accordingly, the light intensity distributions of the object corresponding to the pattern image and intensity image differ from each other, so distribution of distortion within the image differs even though the two images are taken by the same imaging device. With regard to this, conventional measurement apparatuses have had a disadvantage regarding the point of measurement accuracy in performing image calibration using one type of calibration data, regardless of the type of image.

### SUMMARY OF THE INVENTION

Embodiments of the present invention provide, for example, a measurement apparatus advantageous in measurement precision.

A measurement apparatus according to an aspect of the present invention includes: a projection device configured to project, upon an object, light having a pattern and light not having a pattern; an imaging device configured to image the object upon which the light having a pattern has been projected and obtain a pattern image, and image the object upon which the light not having a pattern has been projected and obtain an intensity image; and a processor configured to perform processing of recognizing a region of the object, by performing processing of correcting distortion in the pattern image, based on first calibration data, and performing processing of correcting distortion in the intensity image, based on second calibration data different from the first calibration data.

Further features of the present invention will become apparent from the following description of exemplary embodiments with reference to the attached drawings.

### BRIEF DESCRIPTION OF THE DRAWINGS

FIG. 1 is a diagram illustrating a configuration example of a measurement apparatus.

FIG. 2 is a diagram exemplifying a processing flow in a measurement apparatus.

FIGS. 3A and 3B are diagrams illustrating configuration examples of calibration mark members.

FIG. 4 is another diagram illustrating the configuration example (FIG. 1) of the measurement apparatus.

FIG. 5 is a diagram exemplifying pattern light.

FIG. 6 is a diagram exemplifying a first calibration mark for pattern images.

FIG. 7 is a diagram exemplifying a second calibration mark for intensity images.

FIGS. 8A through 8C are diagrams for describing the relationship between second calibration marks and a point spread function.

FIGS. 9A and 9B are diagrams exemplifying pattern light.

FIG. 10 is a diagram exemplifying a first calibration mark.

FIG. 11 is a diagram exemplifying a first calibration mark.

### DESCRIPTION OF THE EMBODIMENTS

Embodiments of the present invention will be described below with reference to the attached drawings. Note that throughout all drawings for describing the embodiments, the same members and the like are denoted by the same reference symbols as a rule (unless stated otherwise), and redundant description thereof will be omitted.

### First Embodiment

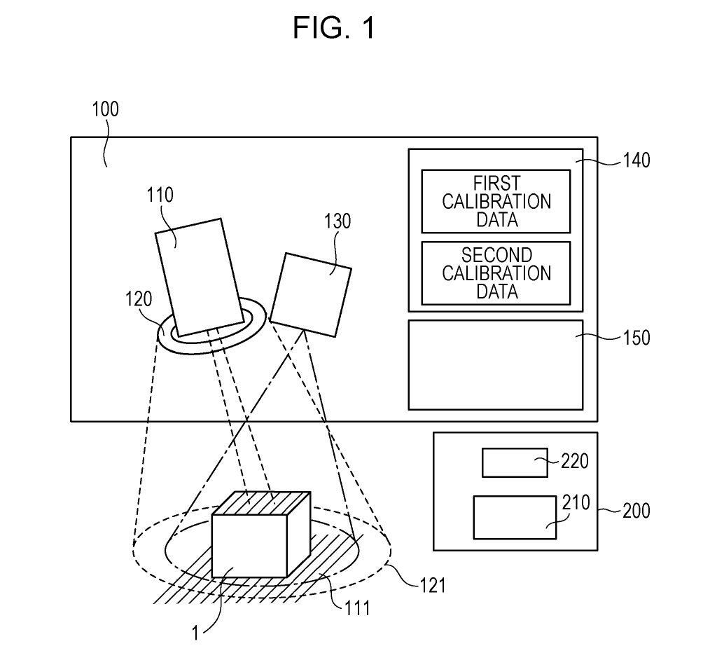

FIG. 1 is a diagram illustrating a configuration example of a measurement apparatus 100 according to a first embodiment. The measurement apparatus 100 in FIG. 1 includes a projection device (first projection device 110 and second projection device 120), an imaging device 130, a storage unit 140, and a processor 150. Reference numeral 1 in FIG. 1 denotes an object (subject). Reference numeral 111 denotes patterned light (pattern light or light having a first pattern) and 121 denotes unpatterned light (non-pattern light, light not having the first pattern, light having a second pattern that is different from the first pattern, or illumination light having an illuminance that is (generally) uniform. The first projection device 110 projects the pattern light 111 on the object 1. The second projection device 120 projects the illumination light 121 (non-pattern light) on the object 1. The imaging device 130 images the object 1 upon which the pattern light 111 has been projected and obtains a pattern image (first image), and images the object 1 upon which the illumination light 121 has been projected and obtains a intensity image (second image that is different from the first image). The storage unit 140 stores calibration data. The calibration data includes data to correct distortion in the image obtained by the imaging device 130.

The storage unit 140 stores, as calibration for correcting distortion of the image, calibration data for the pattern image (first calibration data) and calibration data for the intensity image (second calibration data that is different from the first calibration data). The processor 150 performs processing for correcting distortion of the pattern image based on the first calibration data, and performs processing of correcting distortion of the intensity image based on the second calibration data, thereby carrying out processing of recognizing the region of the object 1. Note that the object 1 may be a component for manufacturing (processing) an article. Reference numeral 210 in FIG. 1 is a processing device (e.g., a robot (hand)) that performs processing of the component, assembly thereof, supporting and/or moving to that end, and so forth (hereinafter collectively referred to as “processing”). Reference numeral 220 denotes a control unit that controls this processing device 210. The control unit 220 receives information of the region of the object 1 (position and attitude) obtained by the processor 150 and controls operations of the processing device 210 based on this information. The processing device 210 and control unit 220 together make up a processing apparatus 200 for processing the object 1. The measurement apparatus 100 and processing apparatus 200 together make up of a processing system.

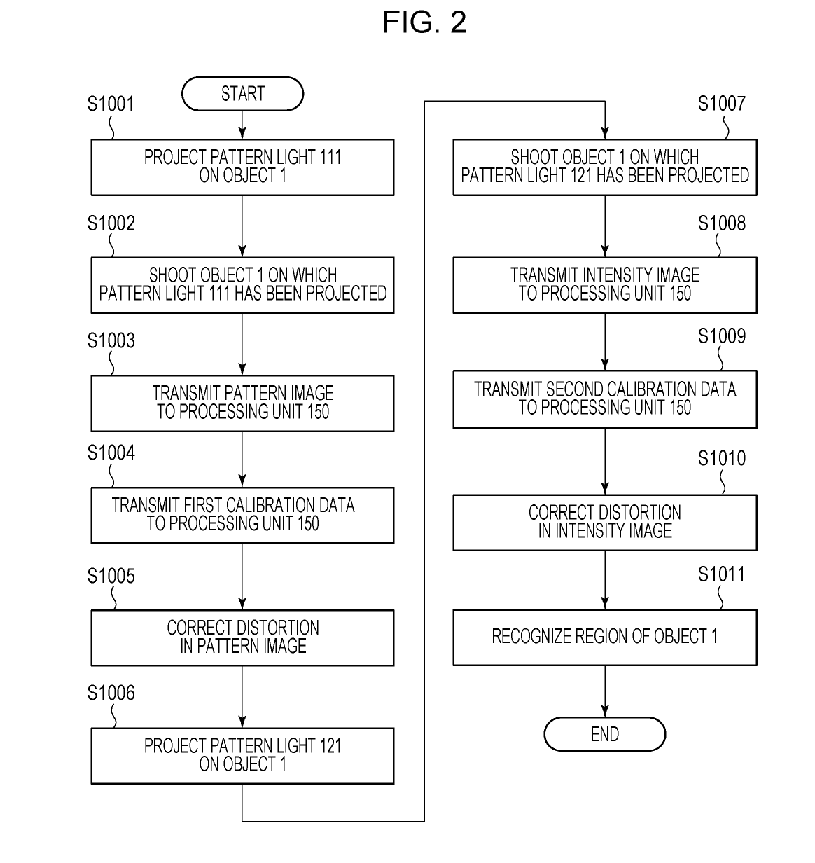

FIG. 2 is a diagram exemplifying a processing flow in the measurement apparatus 100. In FIG. 2, the first projection device 110 first projects the pattern light 111 upon the object 1 (step S1001). Next, the imaging device 130 images the object 1 upon which the pattern light 111 has been projected, and obtains a pattern image (S1002). The imaging device 130 then transmits the pattern image to the processor 150 (step S1003). The storage unit 140 transmits the stored first calibration data to the processor 150 (step S1004). The processor 150 then performs processing to correct the distortion of the pattern image based on the first calibration data (step S1005).

Next, the second projection device 120 projects the illumination light 121 on the object 1 (step S1006). The imaging device 130 images the object 1 upon which the illumination light 121 has been projected, and obtains an intensity image (S1007). The imaging device 130 then transmits the intensity image to the processor 150 (step S1008). The storage unit 140 transmits the stored second calibration data to the processor 150 (step S1009). The processor 150 then performs processing to correct the distortion of the intensity image based on the second calibration data (step S1010).

Finally, the processor 150 recognizes the region of the object 1 based on the calibrated pattern image and calibrated intensity image (step S1011). Note that known processing may be used for the recognition processing in step S1011. For example, a technique may be employed where fitting of a three-dimensional model expressing the shape of the object is performed to both of an intensity image and range image. This technique is described in “A Model Fitting Method Using Intensity and Range Images for Bin-Picking Applications” (Journal of the Institute of Electronics, Information and Communication Engineers, D, Information/Systems, J94-D(8), 1410-1422). The physical quantity being measured differs between measurement error in intensity images and the measurement error in range images, so simple error minimization cannot be applied. Accordingly, this technique obtains the range (position and attitude) of the object by maximum likelihood estimation, assuming that the errors contained on the measurement data of different physical quantities each follow unique probability distributions. Note that the pattern light 111 may be used to obtain the range image, and non-pattern light 121 may be used to obtain the intensity image.

The order of processing in the steps in FIG. 2 is not restricted to that described above, and may be changed as suitable. Transmission of calibration data from the storage unit 140 to the processor 150 (steps S1004 and S1009) may be performed together. Although the processing in FIG. 2 is illustrated in FIG. 2 as being performed serially, at least part may be performed in parallel. The image calibration in steps S1005 and S1010 is not restricted to being performed as to the entire image, and may be performed as to part of the image, such as to characteristic points (e.g., a particular pattern or edge) of the like in pattern images and intensity images, for example.

As described above, processing is performed in the present embodiment where distortion in a pattern image is corrected based on first calibration data, distortion in a intensity image is corrected based on second calibration data, and the range of the object 1 is recognized. Accordingly, pattern images and intensity images that have different distortion amounts from each other can be accurately calibrated, and consequently a measurement apparatus (recognition apparatus) that is advantageous from the point of measurement accuracy (recognition accuracy) can be provided.

### Second Embodiment

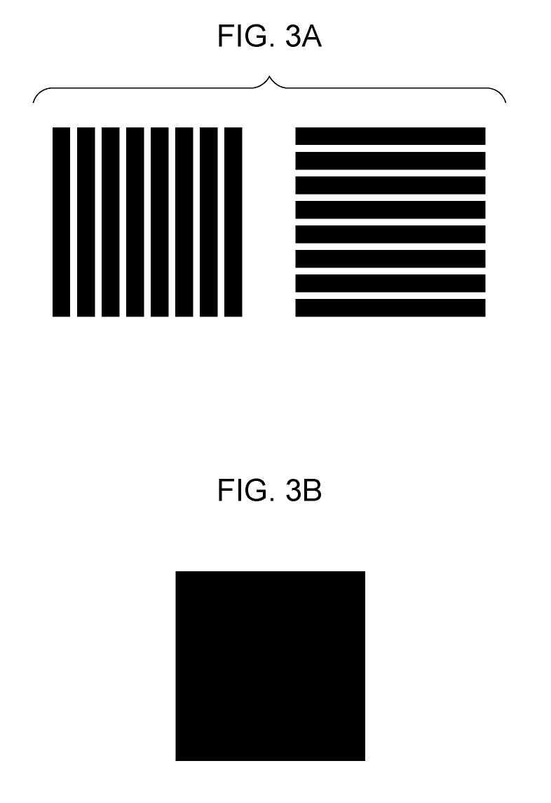

A second embodiment relates to a calibration mark member. FIGS. 3A and 3B are diagrams illustrating configuration examples of the calibration mark member. A calibration mark member is a member including a calibration mark used to obtain the above-described calibration data. Obtaining of calibration data is performed based on correspondence relationship between coordinates of the calibration mark on an image obtained by imaging under predetermined conditions the calibration mark (index) of which the three-dimensional coordinates are known, and the known coordinates. For example, calibration may be performed by placing a calibration member (calibration mark member) having the form of a flat plane, and including multiple calibration marks, of which the relationship in relative position (position coordinates) is known, at a predetermined position in a predetermined attitude. Note that a robot, capable of control of at least one of position and attitude, may perform this placement by supporting the calibration mark member.

Now, The imaging device 130 has a point spread function dependent on aberration and the like of the optical system included in the imaging device 130, so images obtained by the imaging device 130 have distortion dependent on this point spread function. This distortion is dependent on the light intensity distribution on the object 1 as well. Accordingly, in the calibration mark member, the first calibration mark for a pattern image is configured such that the first calibration mark (e.g., to which illumination light is projected by the second projection device 120) has light intensity distribution corresponding to the light intensity distribution of the pattern light projected on the object 1 by the first projection device 110. In the same way, the second calibration mark for an intensity image is configured such that the second calibration mark (e.g., to which illumination light is projected by the second projection device 120) has light intensity distribution corresponding to the light intensity distribution on the object 1 to which the illumination light is projected by the second projection device 120. FIG. 3A illustrates an example of the first calibration mark for a pattern image, and FIG. 3B illustrates an example of a second calibration mark for an intensity image. The marks will be described in detail later. Note that the first calibration mark and second calibration mark may respectively be included in separate calibration mark members, rather than being in a common calibration mark member.

According to the present embodiment, correction of distortion in pattern images and correction of distortion in intensity images can be accurately performed, since calibration data (first calibration data and second calibration data) obtained using such calibration marks (first calibration mark and second calibration mark) is used. Consequently, a measurement apparatus (recognition apparatus) that is advantageous from the point of measurement accuracy (recognition accuracy) can be provided. The first calibration mark and second calibration mark in the calibration mark member will be described in detail by way of examples below.

### Example 1

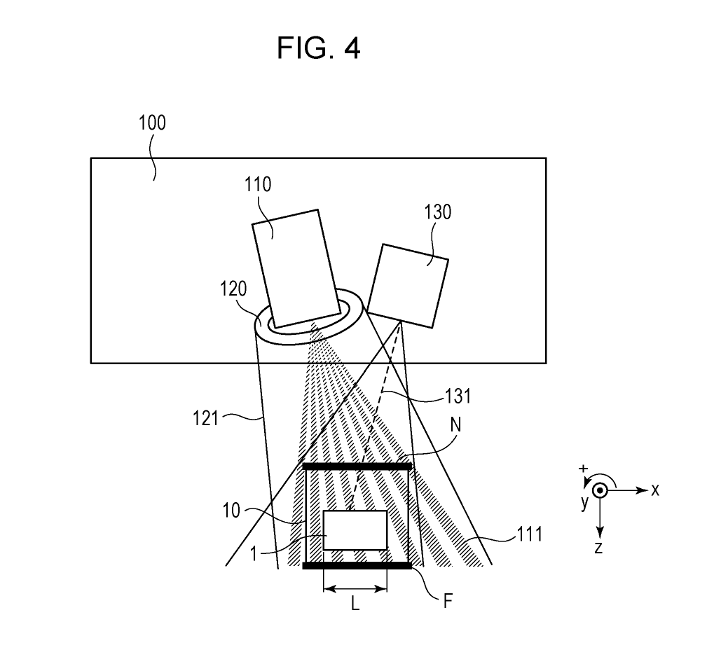

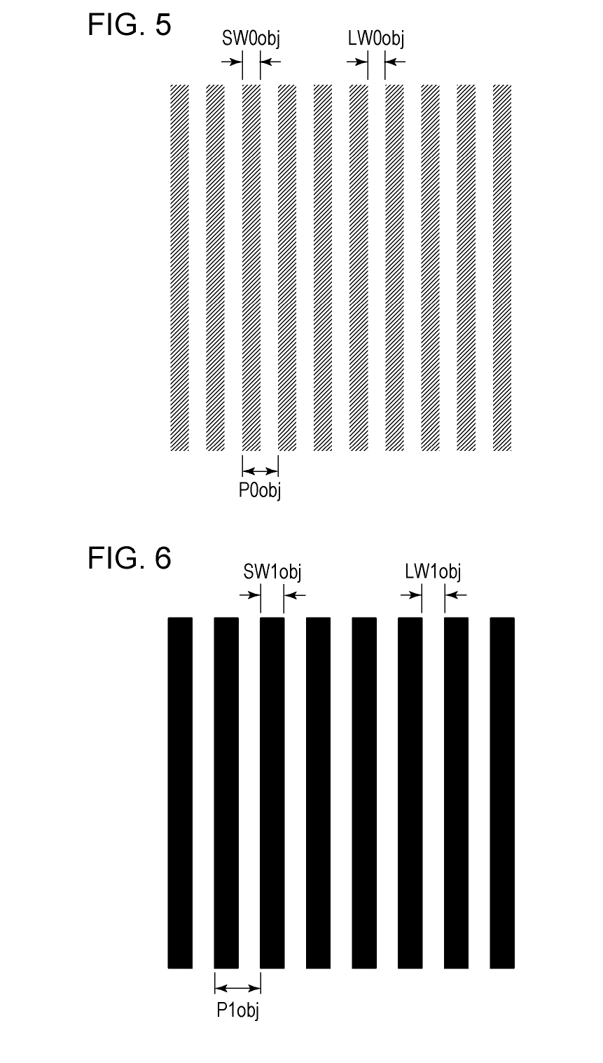

FIG. 4 is another diagram illustrating the configuration example (FIG. 1) of the measurement apparatus. The storage unit 140 and processor 150 are omitted from illustration. A region 10 surrounded by solid lines in FIG. 4 is the measurement region (measurable region) of the measurement apparatus 100. The object 1 is placed in the measurement region 10 and measured. A plane at the measurement region 10 that is closest to the measurement apparatus 100 will be referred to as an N plane (denoted by N in FIG. 4), and a plane that is the farthest therefrom will be referred to as an F plane (denoted by F in FIG. 4). Reference numeral 131 denotes the optical axis of the imaging device 130. FIG. 5 is a diagram exemplifying pattern light. An example of pattern light 111 projected on a cross-section of the measurement region 10 is illustrated here. The pattern light 111 projected by the first projection device 110 is the multiple light portions (multiple linear light portions or stripes of light portions) indicated by white in FIG. 5, while the hatched portions indicate dark portions. The direction in which a stripe of light making up the pattern light 111 extends (predetermined direction) will be referred to as “stripe direction”. The pattern light (multiple stripes of light) extending in the stripe direction are arranged in a direction intersecting (typically orthogonal to) the stripe direction. The width of a light portion orthogonal to the stripe direction is represented by LW0obj, the width of a dark portion is represented by SW0obj, and the width of a light-dark cycle is represented by P0obj. The widths on an image are differentiated from the widths on the object by replacing the suffix “obj” with “img”, so the width of a light portion is LW0img, the width of a dark portion is SW0img, and the width of a light-dark cycle is P0img.

The light portions width LW0img, dark portion width SW0img, and light-dark cycle width P0img on an image change according to the position and attitude of the object (position and attitude of the plane) within the measurement region 10. The relationship between the light-dark cycle width P0img on an image, and the position and attitude of a plane (a surface) of the object 1, will be described below based on the configuration example illustrated in FIG. 4. On the plane of the drawing in FIG. 4, the direction of the base length from the first projection device 110 toward the imaging device 130 is the positive direction of the x axis, a direction perpendicular to the x axis and toward the object 1 is the positive direction of the z axis, and a direction perpendicular to a plane made up of the x axis and y axis and from the far side of the drawing toward the near side is the positive direction of the y axis. The positive direction of rotation where the y axis is a rotational axis is the direction of rotation according to the right-hand rule (the counterclockwise direction on the plane of the drawing in FIG. 4).

Consider a case where any plane perpendicular to the z axis within the measurement region 10 is taken as a reference plane, and this reference plane is rotated on the y axis. Rotating the reference plane in the positive direction makes the light-dark cycle width P0img on the image shorter. On the other hand, rotating the reference plane in the negative direction makes the light-dark cycle width P0img longer. Next, the relationship between the position within the measurement region 10 and the light-dark cycle width P0img will be described. Assuming a pin-hole camera as the model of the imaging device in FIG. 4, the magnification of each of the first projection device 110 and imaging device 130 differs according to the distance between the measurement apparatus 100 and the object 1. Accordingly, the light-dark cycle width P0img on the image differs according to the ratio between the projection magnification of the first projection device 110 and the imaging magnification of the imaging device 130. Accordingly, in a case where this ratio can be deemed to be constant regardless of the position in the measurement region 10, the light-dark cycle width P0img can be deemed to be constant regardless of the position on the image. In a case where this ratio differs depending on the position in the measurement region 10, the light-dark cycle width P0img on the image changes according to the position in the measurement region 10.

Now, a case will be considered where the amount of change in projection magnification due to change in the position within the first projection device 110 is greater than change in imaging magnification due to change in this position. In this case, comparing the light-dark cycle width P0img at different positions by moving the reference plane in the z axis direction in the measurement region 10 shows that the light-dark cycle width P0img is the narrowest at the N plane and the light-dark cycle width P0img is the widest at the F plane. Accordingly, the light-dark cycle width P0img on the image is the narrowest in a case where the plane at the closest position from the measurement apparatus is inclined in the positive direction; the light-dark cycle width P0img in this case will be represented by P0img_min. On the other hand, the light-dark cycle width P0img on the image is the widest in a case where the plane at the farthest position from the measurement apparatus is inclined in the negative direction; the light-dark cycle width P0img in this case will be represented by P0img_max. The position and the range of inclination of this plane are dependent on the measurement region 10 and the measurable angle of the measurement apparatus 100. Accordingly, the light-dark cycle width P0img on the image is the range expressed in the following Expression (1).

P0img_min≦P0img≦P0img_max (1)

As a matter of course, the P0img_min and P0img_max may differ depending on the configuration of the measurement apparatus 100, such as the magnification, layout, etc., of the first projection device and imaging device. Although the light-dark cycle width P0img on the image has the range described above, the ratio between the widths of adjacent light portions and dark portions on the image (ratio of LW0img to SW0img) is generally constant, since the light portion with LW0img and dark portion width SW0img on the image are narrow.

Next, FIG. 6 is a diagram exemplifying a calibration mark for a pattern image (first calibration mark). The first calibration mark illustrated in FIG. 6 is a line/space pattern (“LS pattern” or “LS mark”), made up of light portions indicated by white and dark portions indicated by black. The directions of a line (i.e., a stripe) in the LS pattern may be parallel to the line or stripe direction (predetermined direction) of the pattern light 111. It should be noted that the terms “line” and “stripe” regarding the patterns, marks, and so forth are used interchangeably, and that the term “stripe” has been introduced to prevent misunderstanding of the terminology.

The first calibration mark is a calibration mark for measuring distortion in the image, that is orthogonal to the stripe direction. The width of the light portions in the direction orthogonal to the stripe direction of the LS pattern is represented by LW1, the width of the dark portions is represented by SW1, and the width of the light-dark cycle of the LS pattern, that is the sum of the light portion width LW1 and dark portion width SW1 is represented by P1. The suffix “obj” is added for the actual width (width on the object), so that the width of the light portion is LWiobj, the width of the dark portion is SWiobj, and the width of the light-dark cycle is P1obj. The suffix “img” is added for the width on an image, so that the width of the light portion is LW1img, the width of the dark portion is SW1img, and the width of the light-dark cycle is P1img.

The light portion width LW1obj, dark portion width SW1obj, and light-dark cycle width P1obj of the first calibration mark for the pattern image on the object (dimensions of the predetermined pattern in the first calibration mark) are decided as follows. That is, the light portion width LW1img, the dark portion width SW1img, and the light-dark cycle width P1img of the first calibration mark on an image are decided so as to correspond to the light portion width LW1obj, dark portion width SW0img, and light-dark cycle width P1img in the pattern image. The light-dark cycle width P0img here is an example of dimensions of the predetermined pattern in the pattern image. More specifically, the ratio of the light portion width LW1obj and dark portion width SW1obj of the first calibration mark on the object is made to be the same as the light portion width LW0img and dark portion width SW0img of the pattern light 111 on the image. The light-dark cycle width P1img of the first calibration mark on the object is selected so that the light-dark cycle width P1img on the image corresponds to the light-dark cycle width P0img of the pattern light 111 on the image. Note however, that the light-dark cycle width P0img of the pattern light 111 on the image has the range in Expression (1), so the light-dark cycle width P1img is selected from this range. For example, the light-dark cycle width P1obj of the first calibration mark on the object may be decided based on the average (median) of the P0img_min (minimum value) and P0img_max (maximum value). If estimation can be made beforehand from prior information relating to the object 1, the light-dark cycle width P0obj of the first calibration mark on the object may be decided based on a width P0img regarding which the probability of occurrence is estimated to be highest.

Note that the first calibration mark for the pattern image is not restricted to a single LS pattern, and may include multiple LS patterns having different light-dark cycle widths P1obj from each other. In this case, the LS pattern for obtaining calibration data may be selected based on the relative position between the measurement apparatus and calibration mark member. For example, the light-dark cycle width P0img of the pattern light 111 on the image is measured or estimated regarding the placement of the calibration mark member (at least one of position and attitude). An LS pattern can then be selected where a light-dark cycle width P1img is obtained that is the closest to the width obtained by the measurement or estimation.

Also, an arrangement may be made where calibration data is obtained beforehand corresponding to each of multiple combinations between multiple LS patterns and multiple placements, although this is not restrictive. In this case, calibration data obtained beforehand, based on an LS pattern having a light-dark cycle width P1img on the image that corresponds to (e.g., the closest) the light-dark cycle width P0img in the pattern image, can be used for measurement.

The first calibration mark has a size (dimensions) such that distortions within the image can be deemed to be the same. The first calibration mark is not restricted to having the LS pattern illustrated in FIG. 6 (first LS pattern) such as in FIG. 3A, and may include an LS pattern having a stripe direction rotated 90° as to the first LS pattern (second LS pattern). In this case, coordinates (distortion) on the image orthogonal to the stripe direction of the first LS pattern can be obtained from the first LS pattern, and coordinates (distortion) on the image orthogonal to the stripe direction of the second LS pattern can be obtained from the second LS pattern. Using such a first calibration mark for pattern images is advantageous with regard to accuracy in correction of distortion in pattern images.

Next, description will be made regarding the second calibration mark for intensity images. An image obtained by the imaging device 130 imaging the object 1 on which the illumination light 121 has been projected from the second projection device 120 is the intensity image. Here, a distance between an edge XR and an edge XL (inter-edge distance i.e., distance between predetermined edges) on an object (object 1) is represented by Lobj, and inter-edge distance on an image (intensity image) is represented by Limg. Focusing on the inter-edge distance in the x direction in FIG. 4, the inter-edge distance Lobj on the object does not change, but the inter-edge distance Limg on the image changes according to the placement (position and attitude) of a plane of the object 1 as to the object 1. In a case where a plane having an inter-edge distance Lobj on the object 1 is orthogonal to an optical axis 131 of the imaging device 130, the rotational angle θ of this plane is θ=0. The magnification of the imaging device 130 (imaging magnification) is represented by b. The edge XP when this plane has been rotated by the rotational angle θ is edge XRθ, and the edge XL is edge XLθ. Points obtained by projecting the edge XRθ and XLθ on a plane where rotational angle θ=0 in a pin-hole camera model are XRθ′ and XLθ′, respectively. The inter-edge distance Limg on the image at rotational angle θ can be expressed by Expression (2)

Limg=Lobj′×b (2)

where Lobj′ represents this distance between edge XRθ′ and edge XLθ′ (inter-edge distance).

The range of the rotational angle θ is π/2>|θ|, because a plane having inter-edge distance Lobj will be in a blind spot from the imaging device if the rotational angle θ is π/2≦|θ|. In practice, the limit of the rotational angle θ (θmax) where edges can be separated on the image is determined by resolution of the imaging device and so forth, so the range that θ can actually assume is even narrower, i.e., θmax>|θ|.

In the example in FIG. 4, a pin-hole camera is assumed as the model for the imaging device, so the magnification of the imaging device 130 differs depending on the distance between the measurement apparatus and the object. If the object 1 is at the N plane in the measurement region 10, the inter-edge distance Limg is the longest, and if the object 1 is at the F plane in the measurement region 10, the inter-edge distance Limg is the shortest. Accordingly, a case where the inter-edge distance Limg on the image is shortest is a case where the object 1 is situated at a position farthest from the measurement apparatus 100, and also the plane of the object 1 is not orthogonal to the optical axis 131; the inter-edge distance Limg in this case is represented by Limg_min. A case where the inter-edge distance Limg on the image is longest is a case where the object 1 is situated at a position closest the measurement apparatus 100, and also the plane of the object 1 is orthogonal to the optical axis 131; the inter-edge distance Limg in this case is represented by Limg_max. The position and inclination range of this plane is dependent on the measurement region 10 and measurable angle of the measurement apparatus. Accordingly, the inter-edge distance Limg on the image can be expressed by the following Expression (3).

Limg_min≦Limg≦Limg_max (3)

Now, the inter-edge distance Lobj may differ depending on the shape of the object 1. Also, in a case where there are multiple objects 1 within the measurement region 10, the inter-edge distance Limg on the image may change according to the position/attitude of the object 1. The shortest inter-edge distance on the object is represented by Lmin, the shortest of inter-edge distances on the image in that case is represented by Lmin_img_min, the longest inter-edge distance on the object is represented by Lmax, and the longest of inter-edge distances on the image in that case is represented by Lmin_img_max. The inter-edge distance Limg on the image thus can be expressed by the following Expression (4).

Lmin_img_min≦Limg≦Lmax_img_max (4)

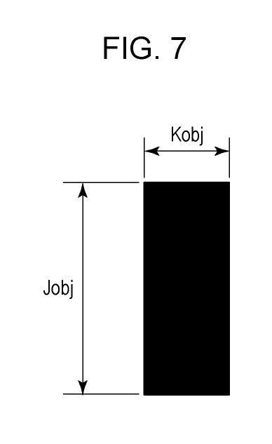

Next, the second calibration mark for intensity images will be described in detail. FIG. 7 is a diagram exemplifying the second calibration mark for intensity images. The background in FIG. 7 is indicated by white (light), and the second calibration mark by black (dark). The second calibration mark may include a stripe-shaped pattern following the stripe direction (predetermined direction). The width of the short side direction of the dark portion is represented by Kobj, and the width of the long side direction of the dark portion is represented by Jobj. The width of the dark portion on the image obtained by imaging the second calibration mark by the imaging device 130 is represented by Kimg. The dark portion width Kobj of the second calibration mark (dimensions of predetermined pattern in second calibration mark) may be decided so that the dark portion width Kimg on the image corresponds to the inter-edge distance Limg on the image (predetermined inter-edge distance in the intensity image). Note however, that the inter-edge distance Limg on the image has the range in Expressions (3) or (4) (range from minimum value to maximum value), so the dark portion width Kimg on the image is selected based on this range. Alternatively, An inter-edge distance Limg on the image of which the probability of occurrence is highest may be identified based on a intensity image obtained beforehand or on estimation.

Multiple marks having different dark portion widths Kobj on the object from each other may be used for the second calibration mark. In this case, calibration data is obtained from each of the multiple markers. An inter-edge distance Limg on the image is obtained from the intensity image at each image height, and correlation data obtained from the second calibration mark that has dark portion width Kimg on the image that corresponds to (e.g., the closest) this inter-edge distance Limg, is used for measurement.

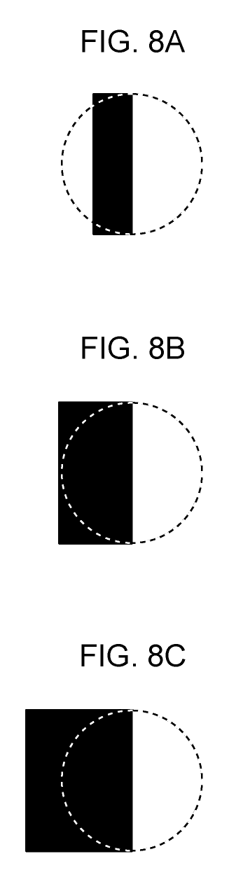

Now, the dark portion width Jobj on the object has a size (dimensions) such that distortions within this width in the image obtained by the imaging device 130 can be deemed to be the same. The dark portion width Kimg on the image may be decided based on the point spread function (PSF) of the imaging device 130. Distortion of the image is found by convolution of light intensity direction on the object and the point spread function. FIGS. 8A through 8C are diagrams for describing the relationship between the second calibration mark and a point spread function. FIGS. 8A through 8C illustrate three second calibration marks that have different dark portion widths Kobj from each other. The circles (radius H) indicated by dashed lines in FIGS. 8A through 8C represent the spread of the point spread function, with the edges of the right sides of the marks being placed upon the centers of the circles. FIG. 8A illustrates a case where Kobj<H, FIG. 8B illustrates a case where Kobj=H, and FIG. 8C illustrates a case where Kobj>H. In the case of FIG. 8A, the light portion that is the background to the left side of the mark is in the point spread function. Accordingly, the light portion that is the background to the left side of the mark influences the edge at the right side of the mark. Conversely, the light portion that is the background to the left side of the mark is not in the point spread function in FIGS. 8B and 8C. Accordingly, the light portion that is the background to the left side of the mark does not influence the edge at the right side of the mark. The dark portion width Kobj is different between FIGS. 8B and 8C, but both satisfy the relationship of Kobj H (where H is ½ the spread of the point spread function), so the amount of distortion at the right side edge is equal. Accordingly, the dimensions of the second calibration mark preferably are ½ or larger than this spread. Now, an arrangement where Kobj=H enables the size of the mark to be reduced, and accordingly a greater number of marks can be laid out on the calibration mark member, for example. Note that the dimensions (e.g., width of light portion) of the patterned light (pattern light) on the object are equal to or larger than the spread of the point spread function of the imaging device 130. Accordingly, the dimensions of the first calibration mark are set to be equal to or larger than the spread of the point spread function of the imaging device 130, in order to obtain an amount of distortion using the first calibration mark that is equivalent or of an equal degree to the amount of distortion that the pattern image has.

The calibration mark member may also include a pattern where the pattern illustrated in FIGS. 8A through 8C (first rectangular pattern) has been rotated 90° (second rectangular pattern) as a second calibration mark. Coordinates (distortion) on the image in the direction orthogonal to the long side direction of the first rectangular pattern can be obtained from the first rectangular pattern, and coordinates (distortion) on the image in the direction orthogonal to the long side direction of the second rectangular pattern can be obtained from the second rectangular pattern. Alternatively, an arrangement may be made where coordinates (distortion) on the image in the two orthogonal directions are obtained from a single pattern, as in FIG. 3B.

Using a second calibration mark for intensity images such as described above is advantageous with regard to the point of accuracy in correcting distortion in intensity images. Using the first calibration mark and second calibration mark such as described above enables a measurement apparatus that is advantageous in terms of measurement precision. Although the width of the dark portions of the second calibration mark have been made to correspond to the inter-edge distance in intensity images in the present example, this is not restrictive, and may be made to correspond to distances between various types of characteristic points. In a case of performing region recognition by referencing values of two particular pixels in a intensity image, for example, the width of the dark portions of the second calibration mark may be made to correspond to the distance between the coordinates of these two pixels.

### Example 2

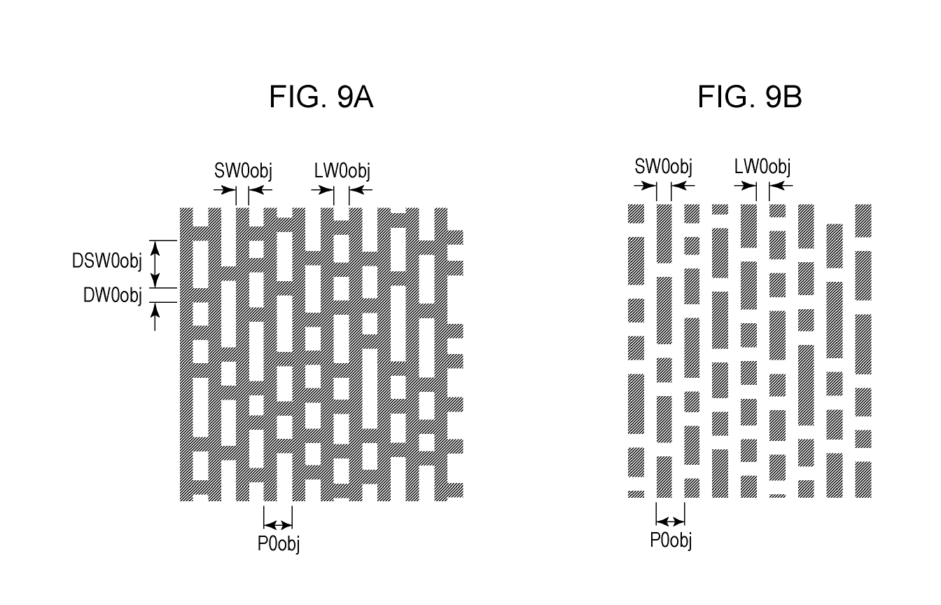

FIGS. 9A and 9B are diagrams exemplifying pattern light. Pattern light is in the form of a stripe or line on the plane onto which it is projected, with the stripe of a light portion or dark portion having a gap thereupon. FIG. 9A illustrates gaps formed on the light stripes. FIG. 9B illustrates gaps formed on the dark stripes. An arrangement such as that illustrated in FIG. 9A is used here. The direction in which stripes of light making up the pattern light extend will be referred to as “stripe direction” in Example 2 as well. In FIG. 9A, the width of light portions in the pattern light is represented by LW, the width of dark portions is represented by SW, the width of the light-dark cycle, that is the sum of LW and SW, is represented by P, the width of the gaps in the stripe direction is represented by DW, and the distance between gaps in the stripe direction is represented by DSW. A mask is formed to project this pattern light. Widths on the mask are indicated by addition of a suffix “p”, so the width of light portions is LW0p, the width of dark portions is SW0p, the width of the light-dark cycle is P0p, the width of the gaps is DW0p, and the distance between gaps in the stripe direction is DSW0p. Widths on the object are indicated by addition of the suffix “obj”, so the width of light portions is LW0obj, the width of dark portions is SW0obj, the width of the light-dark cycle is P0obj, the width of the gaps is DW0obj, and the distance between gaps in the stripe direction is DSW0obj. Widths on the image are indicated by addition of the suffix “img”, so the width of light portions is LW0img, the width of dark portions is SW0img, the width of the light-dark cycle is P0img, the width of the gaps is DW0img, and the distance between gaps in the stripe direction is DSW0img.

The gaps are provided primarily for encoding the pattern light. Accordingly, one or both of the gap width DW0p and inter-gap distance may not be constant. The ratio of the light stripe width LW0img and dark portion width SW0img on the image is generally constant, as described in Example 1, and the light-dark cycle width P0img on the image may assume a value in the range in Expression (1). In the same way, the ratio of the gap width DW0img and inter-gap distance DSW0img on the image is generally constant, and the gap width DW0img and inter-gap distance DSW0img on the image may assume values in the ranges in Expressions (5) and (6).

DW0img_min≦DW0img≦DW0img_max (5)

DSW0img_min≦DSW0img≦DSW0img_max (6)

Assumption has been made here that the change in imaging magnification due to change in position within the measurement region 10 is greater than change in projection magnification due to change in the change in position. The DW0img_min and DSW0img_min in the Expressions are the DW0img and DSW0img under the conditions that the object 1 is at the farthest position from the measurement apparatus, and that the plane of the object 1 is inclined in the positive direction. The DW0img_max and DSW0img_max in the Expressions are the DW0img and DSW0img under the conditions that the object 1 is at the nearest position to the measurement apparatus, and that the plane of the object 1 is inclined in the negative direction.

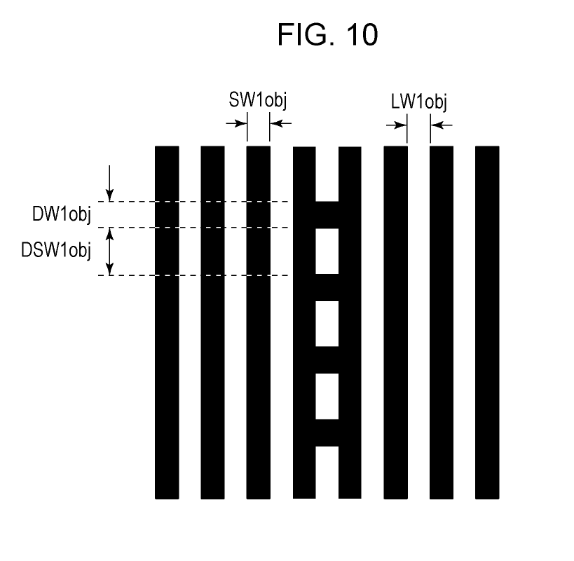

Next, FIG. 10 is a diagram exemplifying a first calibration mark. In FIG. 10, the first calibration mark for pattern images is the light portion indicated by white, and the background is the dark portion indicated by black. The arrangement illustrated here is the same as that in Example 1, except that the gaps have been added to the first calibration mark in Example 1. The width of the gaps of the first calibration mark is represented by DW1, and the distance between gaps is represented by DSW1. The width and distance on the subject (object 1) is indicated by adding the suffix “obj”, so that the width of the gaps is DW1obj, and the distance between gaps is DSW1obj. The width and distance on the image is indicated by adding the suffix “img”, so that the width of the gaps is DW1img, and the distance between gaps is DSW1img. Now, the gap width DW1obj on the object may be decided so that the gap width DW1img on the image corresponds to the gap width DW0img on the image. Also, the inter-gap distance DSW1obj on the object may be decided so that the inter-gap distance DSW1img on the image corresponds to the inter-gap distance DSW0img on the image. Note however, that the gap width DW0img and the inter-gap distance DSW0img of the first calibration mark have the ranges indicated by Expressions (5) and (6), so the gap width DW1img on the image and the inter-gap distance DSW1img on the image are selected based on the ranges of Expressions (5) and (6). The first calibration mark in FIG. 10 has gaps on the middle light stripe where the width of the gaps is DW1obj and the distance between gaps is DSW1obj, but the gaps may be provided such that at least one of multiple gaps widths DW1obj and multiple inter-gap distances DSW1obj satisfy the respective expressions (5) and (6). Further, gaps may be provided on all light stripes. Also, multiple types of marks (patterns) may be provided, where at least one of the light-dark cycle width P1obj, gap width DW1obj, and inter-gap distance DSW1obj, on the object, differ from each other. The ratio among the light-dark cycle width P1obj, gap width DW1obj, and inter-gap distance DSW1obj, is to be constant. For example, three types of marks, which are a first mark through a third mark, are prepared. The marks are distinguished by adding a mark No. after the numeral in the symbols for the light-dark cycle width P1obj, gap width DW1obj, and inter-gap distance DSW1obj. The light-dark cycle width P11obj of the first mark is used as a reference, with the light-dark cycle width P12obj of the second mark being 1.5 times that of P11obj, and the light-dark cycle width P13obj of the third mark being 2 times that of P11obj. Also, the gap width DW12obj of the second mark is 1.5 times the gap width DW11obj of the first mark, and the gap width DW13obj of the third mark is 2 times the gap width DW11obj. The same holds for the inter-gap distance DSW1obj as well.

Note that the first calibration mark for pattern images is not restricted to one type of mark, and may include multiple types of marks of which the light-dark cycle width P1obj differs from each other. In this case, the mark for obtaining calibration data may be selected by the relative position/attitude between the measurement apparatus and calibration mark member. For example, the light-dark cycle width P0img on the image of the pattern light 111 at the placement (at least one of position and attitude) of the calibration mark member is measured or estimated. A mark can then be selected where a light-dark cycle width P1img on the image, closest to the width that has been measured or estimated, can be obtained.

Also, an arrangement may be made where calibration data is obtained beforehand corresponding to each of multiple combinations between multiple types of marks and multiple placements, although this is not restrictive. In this case, calibration data obtained beforehand, based on a mark having a light-dark cycle width P1img on the image that corresponds to (e.g., the closest to) the light-dark cycle width P0img in the pattern image, can be used for measurement. Accordingly, in a case of recognizing projecting multiple types of pattern light and recognizing the region of an object, an image can be obtained for each pattern light type (e.g., first and second images), and the multiple images thus obtained can be calibrated based on separate calibration data (e.g., first and second calibration data). In this case, correction of distortion within each image can be performed more appropriately, which can be more advantageous with regard to the point of accuracy in measurement.

The first calibration mark has a size (dimensions) such that distortions within the image can be deemed to be the same. Distortion of the image in the direction orthogonal to the stripe direction can be obtained by the first calibration mark such as illustrated in FIG. 10, by detecting the stripe (width) of the first calibration mark in this orthogonal direction. Further, distortion of the image in the stripe direction can be obtained, by detecting the gaps of the first calibration mark in the stripe direction. Using the first calibration mark for pattern images such as described above is advantageous from the point of accuracy in correcting distortion in pattern images. Using the second calibration mark for intensity images described in Example 1 is advantageous from the point of accuracy in correcting distortion in intensity images. Using the first calibration mark and second calibration mark such as described above enables a measurement apparatus to be provided that is advantageous from the point of measurement accuracy.

### Example 3

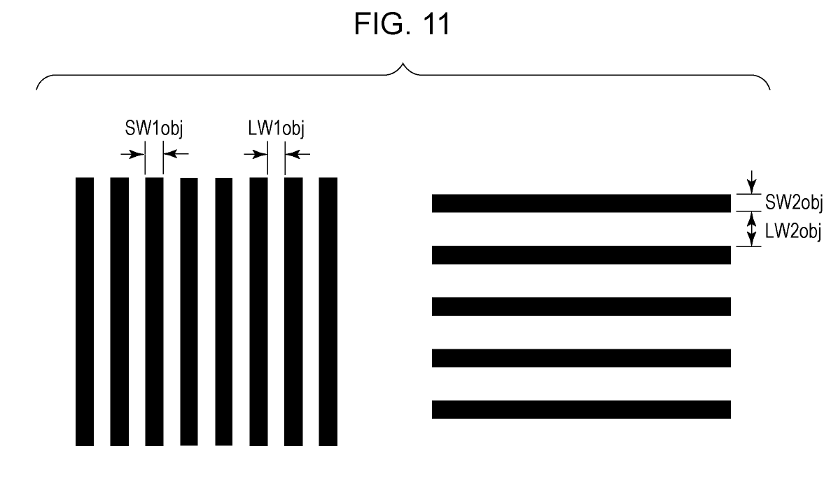

FIG. 11 is a diagram exemplifying a first calibration mark. The first calibration mark in FIG. 11 includes two LS patterns (LS marks) of which the stripe directions are perpendicular to each other. The pattern to the left will be referred to as a first LS pattern, and the pattern to the right will be referred to as a second LS pattern. The first LS pattern is the same as the LS pattern in Example 1, so description thereof will be omitted. In the second LS pattern, the width of light stripes is represented by LW2, and the width of dark stripes is represented by SW2. Widths on the object are indicated by addition of the suffix “obj”, so the width of light stripes is LW2obj, and the width of dark stripes is SW2obj. Widths on the image are indicated by addition of the suffix “img”, so the width of light stripes is LW2img, and the width of dark stripes is SW2img. The ratio of the light stripe width LW2obj and dark stripe width SW2obj in the second LS pattern is the same as the ratio of the light stripe width LW2img and dark stripe width SW2img on the image.

The dark stripe width SW2obj is decided such that the dark stripe width SW2img on the image corresponds to (matches or approximates) the dark stripe width SW0img in the pattern image. The light stripe width LW2obj is also decided such that the light stripe width LW2img on the image corresponds to (matches or approximates) the light stripe width LW0img in the pattern image. The dark stripe width SW0img and light stripe width LW0img in the pattern have ranges, as described in Example 1, so the dark stripe width SW2obj and light stripe width LW2obj are preferably selected in the same way as in Example 1.

Multiple types of marks (patterns) may be provided, where at least one of the dark stripe width SW2obj on the object, light stripe width LW2obj on the object, and light-dark cycle width P2obj on the object, differ from each other. The ratio among the dark stripe width SW2obj on the object, light stripe width LW2obj on the object, and light-dark cycle width P2obj on the object, is to be constant. For example, three types of marks, which are a first mark through a third mark, are prepared. The marks are distinguished by adding a mark No. after the numeral in the symbols for the dark stripe width SW2obj on the object, light stripe width LW2obj on the object, and light-dark cycle width P2obj on the object. The dark stripe width SW21obj on the object of the first mark is used as a reference, with the dark stripe width SW22obj on the object of the second mark being 1.5 times that of SW21obj, and the dark stripe width SW23obj on the object of the third mark being 2 times that of SW21obj. Also, regarding the light stripe width LW21obj on the object of the first mark, the light stripe width LW22obj on the object of the second mark IS 1.5 times that of LW21obj, and the light stripe width LW23obj on the object of the third mark is 2 times that of LW21obj. Further, the same holds true for the light-dark cycle width P2obj on the object as well.

Note that the first calibration mark for pattern images is not restricted to one type of mark, and may include multiple types of marks of which the light-dark cycle width P2obj differs from each other. In this case, the mark for obtaining calibration data may be selected by the relative position/attitude between the measurement apparatus and calibration mark member. For example, the light-dark cycle width P0img on the image of the pattern light 111 at the placement (at least one of position and attitude) of the calibration mark member is measured or estimated. A mark can then be selected where a light-dark cycle width P2img on the image, closest to the width that has been measured or estimated, can be obtained.

Also, an arrangement may be made where calibration data is obtained beforehand corresponding to each of multiple combinations between multiple types of marks and multiple placements, although this is not restrictive. In this case, calibration data obtained beforehand, based on a mark having a light-dark cycle width P2img on the image that corresponds to (e.g., the closest to) the light-dark cycle width P0img in the pattern image, can be used for measurement.

The first calibration mark has a size (dimensions) such that distortions within the image can be deemed to be the same. Using a first calibration mark such as illustrated in FIG. 11, distortion of the image can be obtained regarding the direction orthogonal to the stripe direction in the mark at the left side, by detecting the stripe (width) of this mark in this orthogonal direction. Further, distortion of the image can be obtained regarding the direction orthogonal to the stripe direction in the mark at the right side, by detecting the stripe (width) of this mark in this orthogonal direction. Using the first calibration mark for pattern images such as described above is advantageous from the point of accuracy in correcting distortion in pattern images. Using the second calibration mark for intensity images described in Example 1 is advantageous from the point of accuracy in correcting distortion in intensity images. Using the first calibration mark and second calibration mark such as described above enables a measurement apparatus to be provided that is advantageous from the point of measurement accuracy.

### Modification of First Embodiment

The first and second calibration data in the first embodiment may, in a modification of the first embodiment, be each correlated with at least one parameter obtainable from a corresponding image, and this correlated relationship may be expressed in the form of a table or a function, for example. The parameters obtainable from the images may, for example, be related to light intensity distribution on the object 1 obtained by imaging, or to relative placement between the imaging device 130 and a characteristic point on the object 1 (e.g., a point where pattern light has been projected).

In this case, the first calibration data is decided in step S1005, and then processing is performed based thereupon to correct the distortion in the pattern image. Also, the second calibration data is decided in step S1010, and then processing is performed based thereupon to correct the distortion in the intensity image. Note that the calibration performed in S1005 and S1010 does not have to be performed on an image (or a part thereof), and may be performed as to coordinates on an image obtained by extracting features from the image.

Now, S1005 according to the present modification will be described in detail. Distortion of the image changes in accordance with the light intensity distribution on the object 1, and the point spread function of the imaging device 130, as described earlier. Accordingly, first calibration data correlated with parameters such as described above is preferably decided (selected) and used, in order to accurately correct image distortion. In a case where there is only one parameter value, a singular first calibration data corresponding thereto can be decided. On the other hand, in a case where there are multiple parameter values, the following can be performed, for example. First, characteristic points (points having predetermined characteristics) are extracted from the pattern image. Next, parameters (e.g., light intensity at the characteristic points or relative placement between the characteristic points and the imaging device 130) are obtained for each characteristic point. Next, the first calibration data is decided based on these parameters. Note that the first calibration data may be calibration data corresponding to parameter values, selected from multiple sets of calibration data. Also, the first calibration data may be obtained by interpolation or extrapolation based on multiple sets of calibration data. Further, the first calibration data may be obtained from a function where the parameters are variables. The method of deciding the first calibration data may be selected as appropriate from the perspective of capacity of the storage unit 140, measurement accuracy, or processing time. The same changes made to the processing in S1005 in the first embodiment to obtain the processing in S1005 according to the present modification may be made to the processing in S1010 in the first embodiment, to obtain the processing in S1010 according to the present modification.

### Modification of Example 1

In a modification of Example 1, the first calibration mark for pattern images is not restricted to a single LS pattern, and may include multiple LS patterns having different light-dark cycle widths P1obj from each other within the range of Expression (1). In this case, multiple sets of first calibration data can be obtained, and first calibration data can be decided that matches the light-dark cycle width P0img on the image of the pattern light that changes according to the placement of the object (at least one of position and attitude). Accordingly, more accurate calibration can be performed.

Note that the multiple LS patterns may be provided on the same calibration mark member, or may be provided on multiple different calibration mark members. In the case of the latter, the multiple calibration mark members may be sequentially imaged in order to obtain calibration data. One set of calibration data may be obtained using multiple LS patterns where the light-dark cycle width P1obj differs from each other, or multiple sets of calibration data may be obtained. First, an example of obtaining one set of calibration data will be illustrated. To begin with, images are obtained by imaging a calibration mark member where multiple LS patterns of which the light-dark cycle width P1obj is different from each other are provided. Multiple images where the placement (at least one of position and attitude) of the calibration mark member differ from each other are obtained for these images. From the multiple images are obtained coordinates and light-dark cycle width P1img on the image, for each of the multiple LS patterns where the light-dark cycle width P1obj differs from each other. Next, the light-dark cycle width P0img on the image of the pattern light 111, in a case where the object has assumed the placement (at least one of position and attitude) of the calibration mark member at the time of obtaining each image, is measured or estimated. The LS pattern is selected that yields the closest light-dark cycle width P1img on the image to the width obtained by measurement or estimation out from the multiple LS patterns, where the light-dark cycle within the first calibration mark differs, at the same placement of the calibration mark member. The first calibration data is then obtained based on three-dimensional coordinate information on the object and two-dimensional coordinate information on the object, of the selected LS pattern. Thus, obtaining the first calibration data based on change in the light-dark cycle width P0img due to the relative position and attitude (relative placement) between the measurement apparatus and calibration mark member, enables more accurate distortion correction.

Next, an example of obtaining calibration data correlated with the light-dark cycle width P0img on the image will be described as an example of obtaining multiple sets of calibration data. The process is the same as far as obtaining the coordinates and light-dark cycle width P1img on each image of the multiple LS patterns where the light-dark cycle width P0obj differs from each other in the first calibration marks, based on the images for obtaining calibration data. Thereafter, the range of the light-dark cycle width P0img on the pattern light 111 image, expressed in Expression (1), is divided into an optional number of divisions. The LS patterns of the first calibration marks of all images are grouped based on the light-dark cycle width P1img obtained as described above, for each of the light-dark cycle widths P0img obtained by the dividing. Thereafter, calibration data is obtained based on the three-dimensional coordinates on the object and the coordinates on the image, for the LS patterns in the same group. For example, if the range of the light-dark cycle width P0img on the pattern light 111 image is divided into eleven, this means that eleven types of calibration data are obtained. The correspondence relationship between the ranges of the light-dark cycle width P0img on the image and the first calibration data thus obtained is stored.

The stored correspondence relationship information is used as follows. First, the processor 150 detects the pattern light 111 to recognize the object region from the pattern image. Points where the pattern light 111 is detected are set as detection points. Next, the light-dark cycle width P0img at each detection point is decided. The light-dark cycle width P0img may be the average of the distance between the coordinates of a detection point of interest, and the coordinates of detection points adjacent thereto in a direction orthogonal to the stripe direction of the pattern light 111, for example. Next, the first calibration data is decided based on the light-dark cycle width P0img. For example, first calibration data correlated with the light-dark cycle width closest to P0img may be employed. Alternatively, the first calibration data to be employed may be obtained by interpolation from first calibration data corresponding to P0img. Further, the first calibration data may be stored as a function where the light-dark cycle width P0img is a variable. In this case, the first calibration data is decided by substituting P0img into this function.

Deciding the first calibration data in this way enables more accurate distortion correction to be performed, that corresponds to image distortion having correlation with the light-dark cycle width P0img. Note that the multiple sets of calibration data may correspond to each of the multiple combinations of multiple LS patterns and multiple placements. Now, the multiple placements (relative position between each LS pattern and the imaging device 130) may be decided based on coordinates on each LS pattern on the image and three-dimensional coordinates on the object.

Next, the range of the light-dark cycle width P0img expressed in Expression (1) is divided into an appropriate number of divisions. The range of the position of the object on the optical axis 131 direction of the imaging device 130 (relative placement range, in this case the measurement region between two planes perpendicular to the optical axis) is divided into an appropriate number of divisions. LS patterns are then grouped for each combination of P0img range and relative placement range obtained by the dividing. Calibration data can be calculated based on the three-dimensional coordinates on the object and coordinates on the image, for the LS patterns grouped into the same group. For example, if the P0img range is divided into eleven, and the relative placement range is divided into eleven, 121 types of calibration data will be obtained. The correspondence relationship between the above-described combinations and first calibration data, obtained in this way, is stored.

In a case of recognizing an object region, first, the P0img in the pattern image, and the relative placement are obtained. The relative placement can be decided by selection from multiple ranges obtained by the above dividing. Next, first calibration data is decided based on the P0img and relative placement. First calibration data may be selected that corresponds to the combination. Alternatively, the first calibration data may be obtained by interpolation, instead of making such a selection. Further, the first calibration data may be obtained based on a function where the P0img and relative placement are variables. Thus, first calibration data corresponding to the P0img and relative placement can be used, and distortion can be corrected more accurately.

Now, it is desirable that distortion in the image of the first calibration mark generally match distortion in the pattern image. Accordingly, the first calibration mark has dimensions such that these distortions can be deemed to be the same at a reference position (e.g., center position) within the first calibration mark. Specifically, the first calibration mark has dimensions no less than the spread of the point spread function of the imaging device 130, at a reference point of the first calibration mark. This is due to the distortion of the image being determined dependent on the light intensity distribution on the object and the point spread function of the imaging device. If the light intensity distribution on the object within the range of spread of the point spread function of the imaging device can be deemed to be the same, the distortion occurring can be deemed to be the same.

Next, the second calibration mark for intensity images will be described. The second calibration mark in FIG. 7 has a stripe pattern following the stripe direction (predetermined direction), as described above, having a width of the dark portion in the short side direction of Kobj, and a width in the long side direction of Jobj. The second calibration mark in the present modification has a width (Mobj) of the dark portion in the short side direction that is larger than the width Kobj of the second calibration mark in the same direction (the background of the dark portion is a light portion). No other dark portions are provided in the region outside of the dark portion of the width Kobj within the range of the width Mobj.

The second calibration mark may include multiple marks of which the width Kobj on the object differ from each other. In this case, multiple sets of second calibration data of which inter-edge distances on the image differ from each other can be obtained, and second calibration data can be decided according to inter-edge distance on the image that changes depending on the placement (at least one of position and attitude) of the object. Accordingly, more accurate calibration is enabled. Details of the method of obtaining the second calibration data will be omitted, since the light-dark cycle width (P0img) for the first calibration data is simply replaced with the inter-edge distance on the image for the second calibration data.

Next, description will be made regarding the dimensions of the second calibration mark. It is desirable that distortion in the image of the second calibration mark generally match distortion in the intensity image. Accordingly, the second calibration mark has dimensions such that these distortions can be deemed to be the same at a reference position (e.g., center position) within the second calibration mark. Specifically, the second calibration mark has dimensions no less than the spread of the point spread function of the imaging device 130, at a reference point of the second calibration mark. This is due to the distortion of the image being determined dependent on the light intensity distribution on the object and the point spread function of the imaging device. If the light intensity distribution on the object within the range of spread of the point spread function of the imaging device can be deemed to be the same, the distortion occurring can be deemed to be the same.

### Modification of Example 2

A modification of Example 2 is an example where change in projection magnification due to change in position within the measurement region 10 is larger than change in imaging magnification due to this change, which is opposite to the case in Example 2. In this case, the DW0img_min and DSW0img_min in the Expressions (5) and (6) are the DW0img and DSW0img under the conditions that the object 1 is at the closest position to the measurement apparatus, and that the object 1 is inclined in the positive direction. The DW0img_max and DSW0img_max in the Expressions (5) and (6) are the DW0img and DSW0img under the conditions that the object 1 is at the farthest position from the measurement apparatus, and that the object 1 is inclined in the negative direction.

The first calibration mark for pattern images is not restricted to one type of mark, and may include multiple types of marks of which the light-dark cycle width P1obj differs from each other, in the same way as with the modification of Example 1. It is obvious that an example including multiple types of marks can be configured in the same way as the modification of Example 1, so details thereof will be omitted.

### Modification of Example 3

The first calibration mark for pattern images in Example 3 is not restricted to one type of mark, and may include multiple types of marks of which the light-dark cycle width P2obj differs from each other. It is obvious that an example including multiple types of marks can be configured in the same way as the modification of Example 1, so details thereof will be omitted.

### Embodiment Relating to Product Manufacturing Method

The measurement apparatus described in the embodiments above can be used for a product manufacturing method. This product manufacturing method may include a process of measuring an object using the measurement apparatus, and a process of processing an object that has been measured in the above process. This processing may include at least one of processing, cutting, transporting, assembling, inspecting, and sorting, for example. The product manufacturing method according to the present embodiment is advantageous over conventional methods with regard to at least one of product capability, quality, manufacturability, and production cost.

Although the present invention has been described by way of preferred embodiments, it is needless to say that the present invention is not restricted to these embodiments, and that various modifications and alterations may be made without departing from the essence thereof.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processor (CPU), micro processor (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-208241, filed Oct. 22, 2015, and Japanese Patent Application No. 2016-041579, filed Mar. 3, 2016, which are hereby incorporated by reference herein in their entirety.

What is claimed is:

1. A measurement apparatus comprising:
a projection device configured to project, upon an object, light having a pattern and light not having a pattern;
an imaging device configured to
image the object upon which the light having a pattern has been projected and obtain a pattern image, and
image the object upon which the light not having a pattern has been projected and obtain an intensity image; and
a processor configured to perform processing of recognizing a region of the object, by
performing processing of correcting distortion in the pattern image, based on first calibration data, and
performing processing of correcting distortion in the intensity image, based on second calibration data different from the first calibration data.

2. The measurement apparatus according to claim 1, wherein the processor is configured to obtain the first calibration data based on an image of a first calibration mark obtained by the imaging device, and obtain the second calibration data based on an image of a second calibration mark obtained by the imaging device.

3. The measurement apparatus according to claim 2, wherein the projected light having a pattern includes stripes of light each of which is along a predetermined direction.

4. The measurement apparatus according to claim 3, wherein the stripes of light are arranged along a direction orthogonal to the predetermined direction.

5. The measurement apparatus according to claim 3, wherein the stripes of light are arranged along the predetermined direction.

6. The measurement apparatus according to claim 2, wherein the first calibration mark includes plural stripe patterns each of which is along a predetermined direction.

7. The measurement apparatus according to claim 2, wherein the second calibration mark includes a stripe pattern which is along a predetermined direction.

8. The measurement apparatus according to claim 2, wherein a dimension of a predetermined pattern in the first calibration mark corresponds to a dimension of a predetermined pattern in the pattern image.

9. The measurement apparatus according to claim 2, wherein a dimension of a predetermined pattern in the first calibration mark correspond to a dimension within a range from a minimum value to a maximum value of a dimension of a predetermined pattern in the pattern image.

10. The measurement apparatus according to claim 2, wherein a dimension of a predetermined pattern in the second calibration mark corresponds to a distance between predetermined edges in the intensity image.

11. The measurement apparatus according to claim 2, wherein a dimension of a predetermined pattern in the second calibration mark corresponds to a distance within a range from a minimum value to a maximum value of a distance between predetermined edges in the intensity image.

12. The measurement apparatus according to claim 2, wherein a dimension of the first calibration mark is not less than a spread of a point spread function of the imaging device.

13. The measurement apparatus according to claim 2, wherein a dimension of the second calibration mark is not less than ½ of a spread of a point spread function of the imaging device.

14. The measurement apparatus according to claim 2, wherein the first calibration mark includes plural patterns of which dimensions are different from each other.

15. The measurement apparatus according to claim 2, wherein the second calibration mark includes plural patterns of which dimensions are different from each other.

16. The measurement apparatus according to claim 1, wherein the projected light not having a pattern includes light of which illuminance has been made uniform.

17. The measurement apparatus according to claim 1, wherein the processor is configured to obtain the first calibration data based on at least one of a type of the light having a pattern and a type of the object.

18. The measurement apparatus according to claim 1, wherein the processor is configured to obtain the second calibration data based on a type of the object.

19. The measurement apparatus according to claim 1, wherein the processor is configured to obtain the first calibration data based on the pattern image.

20. The measurement apparatus according to claim 1, wherein the processor is configured to obtain the second calibration data based on the intensity image.

21. A measurement apparatus comprising:
a projection device configured to project, upon an object, light having a first pattern and light having a second pattern different from the first pattern;
an imaging device configured to
image the object upon which the light having the first pattern has been projected and obtain a first image, and
image the object upon which the light having the second pattern has been projected and obtain a second image; and
a processor configured to perform processing of recognizing a region of the object, by
performing processing of correcting distortion in the first image, based on first calibration data, and
performing processing of correcting distortion in the second image, based on second calibration data different from the first calibration data.

22. The measurement apparatus according to claim 21, wherein the processor is configured to obtain the first calibration data based on the first image.

23. The measurement apparatus according to claim 21, wherein the processor is configured to obtain the second calibration data based on the second image.

24. A method of manufacturing an article, the method comprising steps of:
measuring an object using a measurement apparatus; and
processing the measured object to manufacture the article,
wherein the measurement apparatus includes
a projection device configured to project, upon an object, light having a first pattern and light having a second pattern different from the first pattern;
an imaging device configured to
image the object upon which the light having the first pattern has been projected and obtain a first image, and
image the object upon which the light having the second pattern has been projected and obtain a second image; and
a processor configured to perform processing of recognizing a region of the object, by
performing processing of correcting distortion in the first image, based on first calibration data, and
performing processing of correcting distortion in the second image, based on second calibration data that different from the first calibration data.

25. A measurement method comprising steps of:
projecting light having a pattern upon an object;
imaging the object upon which the light having a pattern has been projected and obtaining a pattern image;
projecting light not having a pattern on the object;
imaging the object upon which the light not having a pattern has been projected and obtaining an intensity image; and
recognizing a region of the object, by
performing processing of correcting distortion in the pattern image, based on first calibration data, and
performing processing of correcting distortion in the intensity image, based on second calibration data different from the first calibration data.

26. A measurement method comprising steps of:
projecting light having a first pattern upon an object;
imaging the object upon which the light having the first pattern has been projected and obtaining a first image;
projecting light having a second pattern different from the first pattern upon the object;
imaging the object upon which the light having the second pattern has been projected and obtaining a second image; and
recognizing a region of the object, by
performing processing of correcting distortion in the first image, based on first calibration data, and
performing processing of correcting distortion in the second image, based on second calibration data different from the first calibration data.

27. A computer-readable storage medium which stores a program for causing a computer to execute the measuring method according to claim 26.
